(19) United States
(12) Patent Application Publication
(10) Pub. No.: US 2005/0281284 A1
(43) Pub. Date: Dec. 22, 2005

(54) System and method for broadcasting VoIP messages

(76) Inventors: Choon B. Shim, Ijamsville, MD (US); R. Pierce Ried, Stowe, VT (US); Dongwook Shin, Potomac, MD (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/872,780

(22) Filed: Jun. 22, 2004

(51) Int. Cl. H04Q 11/00

(52) U.S. Cl. 370/465; 370/352

(57) ABSTRACT

The invention relates to a system and method for broadcasting VoIP messages. In one respect, embodiments of the invention utilize random delays to disguise the automated nature of the messaging source. In another respect, embodiments of the invention are configured to persist when error messages are encountered.

### FIELD OF INVENTION

The invention relates generally to the field of telecommunications. More specifically, but not by way of limitation, the invention relates to a system and method for broadcasting Voice over Internet Protocol (VoIP) messages.

### BACKGROUND

Systems and methods are generally known for sending a VoIP message from a source to a destination on a network. But certain applications may require an automated or semi-automated broadcast mode, where a single VoIP message is sent from the source to multiple destinations. Moreover, application requirements may dictate that multiple messages are broadcast to each of one or more destinations.

Known methods for automated or semi-automated messaging broadcasts employ simple looping algorithms to repeatedly send a message to each destination in a predetermined list of destinations. Likewise, a single source may employ a looping algorithm to send multiple messages to a single destination. But such methods for broadcasting VoIP messages may be susceptible to unwanted filtering or blocking at the destination. Another limitation of known broadcasting methods is that the automated process may terminate when errors (e.g., during connection or transmission) are encountered. As a result, human intervention may be required, and broadcast efficiency may be decreased.

It would be advantageous to have a system than can broadcast VoIP messages in a manner that defeats filtering or blocking mechanisms and persists when connection or transmission errors are encountered.

### SUMMARY OF THE INVENTION

The invention relates to a system and method for broadcasting VoIP messages. In one respect, embodiments of the invention utilize random delays to disguise the automated nature of the messaging source. In another respect, embodiments of the invention are configured to persist when error messages are encountered.

Embodiments of the invention provide a method for broadcasting Voice Over IP (VoIP) messages, including: connecting from a source to a first destination; pausing for a first random duration; and sending a first VoIP message from the source to the first destination. An embodiment provides machine-readable medium having instructions for performing the foregoing method.

Embodiments of the invention provide a method for controlling a transmission of a Voice Over IP (VoIP) message by a source, including: detecting a connection between the source and a first destination; setting a first delay to a first duration; and at the expiration of the first delay, transmitting a first VoIP message intended for the first destination from the source. An embodiment provides machine-readable medium having instructions for performing the foregoing method.

Embodiments of the invention provide a method for broadcasting Voice Over IP (VoIP) messages, including: means for connecting from a source to a first destination; pausing for a first random duration; and sending a first VoIP message from the source to the first destination.

Embodiments of the invention provide a system for broadcasting Voice Over IP (VoIP) messages, including: a source terminal; an interface to a SIP server coupled to the source terminal; and an interface to a first destination terminal, the interface to the destination terminal coupled to the SIP server, the source terminal configured to detect a connection between the source and a destination, the source terminal further configured to set a first delay to a first duration, the source terminal further configured to transmit a first VoIP message to the destination after the expiration of the first delay.

Some benefits of the invention are evident by considering the useful VoIP broadcast applications that are enabled by the invention. For example, by improving the likelihood of broadcast message delivery, commercial entities are better able to send bulk voicemail to their customers, non-profit entities are more easily able to contact potential contributors, organizations improve their ability to contact members with information of broad interest, and emergency alerting services are better able to provide warnings and/or instructions to targeted populations.

The features and advantages of the invention will become apparent from the following drawings and detailed description.

### BRIEF DESCRIPTION OF THE DRAWINGS

Embodiments of the invention are described with reference to the following drawings, wherein:

FIG. 1 is a flow diagram of a method for broadcasting VoIP messages, according to an embodiment of the invention;

FIG. 2A is a flow diagram of a method for broadcasting VoIP messages, according to an embodiment of the invention;

FIG. 2B is a flow diagram of a method for determining connection status, according to an embodiment of the invention;

FIG. 2C is a flow diagram of a method for sending a predetermined message to a destination, according to an embodiment of the invention;

FIG. 3 is a block diagram of a functional architecture configured to broadcast VoIP messages, according to an embodiment of the invention;

FIG. 4 is a sequence diagram of communications between a source terminal, a SIP server, and a destination terminal, according to an embodiment of the invention; and

FIG. 5 is a state diagram of code for broadcasting VoIP messages, according to an embodiment of the invention.

### DETAILED DESCRIPTION

Embodiments of the invention provide systems and methods for broadcasting audible and/or text messages to multiple destinations via one or more IP networks. As used herein, a destination, destination terminal, destination device, or the like, may be any physical or logical device or utility that is coupled to an IP network and configured to receive and/or store data. The coupling to an IP network may be direct or indirect. For example, the destination device may be more directly coupled to the Plain Old Telephone System (POTS) network and more indirectly coupled to an IP network via a gateway between the POTS network and the IP network. Moreover, the destination, destination terminal, destination device, or the like, may be an intermediate destination or an ultimate destination. A router is an exemplary intermediate destination; a voice mailbox is an exemplary ultimate destination.

This section provides exemplary methods, functional architectures, and applications for broadcasting VoIP messages. Sub-headings are used below for organizational convenience. The disclosure of any particular feature is not necessarily limited to any particular section, however. The detailed description begins with a top-level process description.

Methods

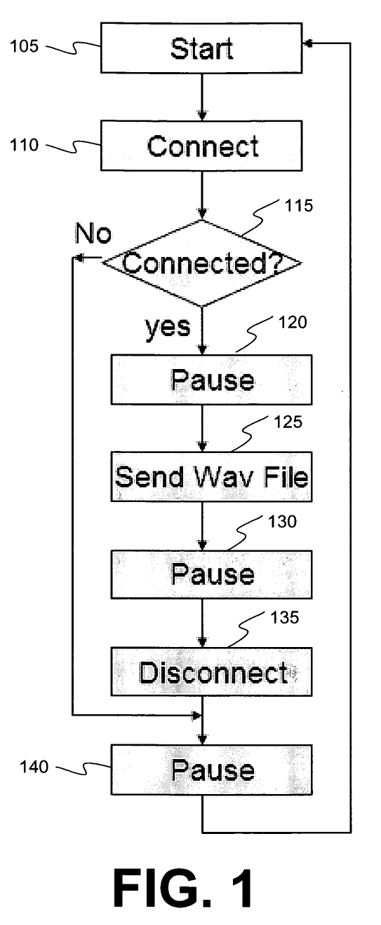

FIG. 1 is a flow diagram of a method for broadcasting VoIP messages, according to an embodiment of the invention. As shown in FIG. 1, the example process starts in step 105, connects a source to a destination in step 110. Then, in conditional step 115, it is determined whether the connection was successful.

If it is determined in step 115 that the attempted connection was successful, the process advances to a first pause step 120 before sending a wave (.wav) or other audio file format (e.g., a file having a .mp2, .mp3, .ra, .voc, or other file extension) in step 125. Next, the process advances to step 130 for a second pause step before disconnecting the destination from the source in step 135. Finally, the process advances to a third pause step 140 before returning to the start step 105. Where the result of conditional step 115 is in the negative, the process advances directly to the third pause step 140.

In embodiments of the invention, one or more of the first pause step 120, second pause step 130, and third pause step 140 have random durations. Accordingly, the timing of the process illustrated in FIG. 1 will generally vary each time it is repeated, disguising its automated or semi-automated nature.

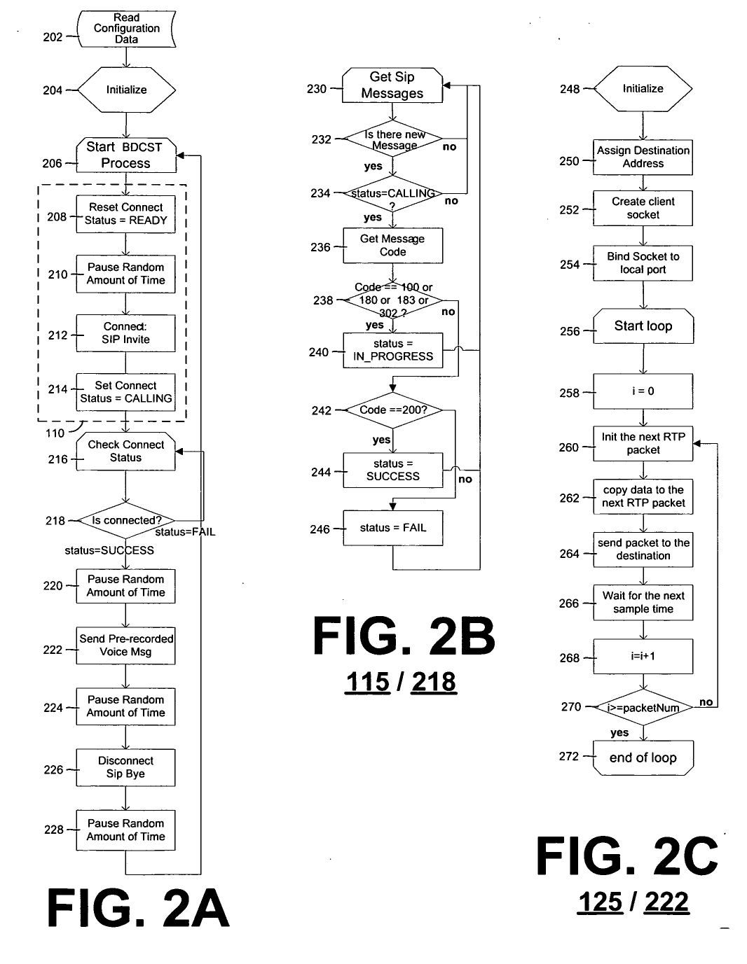

Variations of the process described above are also contemplated. For example, up to two of the pause steps 120, 130, and 140 may be deleted, relying on only one or possibly two pause steps to provide the random timing character. In addition, sending step 125 may send a communication in a format other than a .wav file, according to design choice. In the alternative to, or in combination with sending an audio file in step 125, a text message may be sent. A more detailed embodiment of the process shown in FIG. 1 is described below with reference to FIGS. 2A, 2B, and 2C.

FIG. 2A is a flow diagram of a method for broadcasting VoIP messages, according to an embodiment of the invention. The process begins by reading configuration data in step 202 before advancing to initialization step 204. The configuration data in step 202 may include, for example, the SIP IP address, port, user name, password, or codec information. Step 204 may be or include, for example, user sign-in and/or memory allocation.

Next, a broadcast (BDCST) process is called in step 206, which begins by sequentially resetting a “connect status” parameter to “ready” in step 208, pausing a random amount of time in step 210, connecting via a session initialization protocol (SIP) invite in step 212, and setting a the “connect status” parameter to “calling” in step 214. Together, steps 208, 210, 212, and 214 can be considered one embodiment of connect step 110. Advantageously, step 210 is an additional random pause step beyond the pause steps 120, 130, and 140 illustrated in FIG. 1.

The process then calls a “check connect status” process in step 216, which includes determining whether the source is connected to the destination in conditional step 218. An embodiment of conditional step 218 is further described with reference to FIG. 2B below.

Where the result of conditional step 218 is in the affirmative, e.g., the status equals “success” (a successful connection attempt), the process then pauses a random amount of time in step 220, sends a pre-recorded voice message in step 222, pauses a random amount of time in step 224, disconnects from the SIP in step 226, and pauses a random amount of time in step 228 before returning to the start BDCST process step 206. Where the result of conditional step 218 is in the negative, e.g., status equals “fail,” the process returns to the check connect status step 216. An embodiment of sending step 222 is described below with reference to FIG. 2C.

Many variations to the process illustrated in FIG. 2A are contemplated. For example, the random amounts of time in pause steps 210, 220, 224, and 228 may generally be separately generated, potentially resulting in different durations. In alternative embodiments, two or more pause times in steps 210, 220, 224, and 228 may the same, and any one or more of the pause times in steps 210, 220, 224, and 228 may be non-random. Moreover, any one or more of pause steps 210, 220, 224, and 228 may be eliminated, although it is preferable to have at least one pause step with a random amount of time. In addition, the references to SIP in steps 212 and 226 may be replaced when using other messaging protocols, according to design choice. Further, in the alternative to, or in combination with sending a voice message in step 222, a text message may be sent.

The following source code listing, showing an exemplary code implementation for a portion of the process in FIG. 2A, contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

/*
* This is the main BCDST function. It is called after the initialization step

is complete.

*/
void
UaBDCST::BDCST(const string& input)
{
string::size_type pos;
if((pos = input.find(“BDCST”)) != string::npos)

{

string rhs = input.substr(pos+5);
string ctlString(“INVITE ”);
ctlString += rhs;
cerr << “Calling :” << ctlString << endl;

/* Set the initial seed for random */
srand( (unsigned)time( NULL ) );

while (1)
{

//init status
connStatus = READY;

//Sendit to the Controller

UaBDCST::writeToController(ctlString);
connStatus = CALLING;
//Wait connected
while (connStatus!=FAIL||connStatus!=SUCCESS)
{

sleep (1);

}
int pauseTime, maxPauseTime=10;
if (connStatus==SUCCESS)
{

//pause random
pauseTime = (int) maxpauseTime * rand( ) /
(RAND_MAX + 1.0);
sleep(pauseTime);
//send wave file
UaBDCST::sendVoiceData(recordedMsg, pktLength,
destIp,

destPort);

//pause random
pauseTime = (int) maxPauseTime * rand( ) /
(RAND_MAX + 1.0);
sleep(pauseTime);
//Hangup
writeToController(“STOP”);

}
//pause random
connStatus=WAIT;
pauseTime = (int) maxPauseTime * rand( ) /
(RAND_MAX + 1.0);
sleep(pauseTime);
//return to the next call;

}

}

}

FIG. 2B is a flow diagram of a method for determining connection status, according to an embodiment of the invention. Generally, the check connect status step 216 may be executed by receiving and assessing SIP messages.

As shown in FIG. 2B, the process begins by receiving SIP messages in step 230 and determining whether there is a new SIP message in conditional step 232. Where the result of conditional step 232 is in the affirmative, the process determines whether the status is equal to “calling” in conditional step 234. Where the result of conditional step 234 is in the affirmative, the process advances to receive a message code in step 236. Where the result of conditional steps 232 or 234 are in the negative, the process returns to step 232.

After receiving the message code in step 236, the process determines whether the code is equal to 100 or 180 or 183 or 302 in conditional step 238. Where the result of conditional step 238 is in the affirmative, the status is set equal to “in_progress” in step 240, and the process then return to step 230.

Where the result of conditional step 238 is in the negative, the process determines whether the code is equal to 200 in conditional step 242. Where the result of conditional step 242 is in the affirmative, the process sets the status equal to “success” before returning to step 230. Where the result of conditional step 242 is in the negative, the process sets status equal to “fail” before returning to step 230.

Accordingly, where SIP messaging protocol is used, SIP messages and predetermined codes in the SIP messages can be exploited to determine whether the source is connected to the destination.

The following source code listing, showing an exemplary code implementation for a portion of the process in FIG. 2B, contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

/*
* This is the callback function when the listening thread posts when there

is new sip message.

*/
void
UaBDCST::postMsg(Sptr<SipMsg> sMsg)
{

assert(sMsg != 0);
strstream s;

cpLog(LOG_DEBUG, “MSG :%s” , sMsg->encode( ).
logData( ));

if(sMsg->getType( ) == SIP_STATUS)
{

Sptr<StatusMsg> statusMsg;
statusMsg.dynamicCast(sMsg);
assert(statusMsg != 0);
int statusCode = statusMsg->getStatusLine( ).getStatusCode( );
if(statusMsg->getCSeq( ).getMethod( ) != INVITE_METHOD)
{

s << “INFO ”;

}
else
{

switch(statusCode)
{

case 100:
{

s << “TRYING ”;

connStatus = IN_PROGRESS;

}
break;
case 180:
case 183:
{

cerr << “RINGING:” << endl;
s << “RINGING ”;

connStatus = IN_PROGRESS;

}
break;
case 200:
{

s << “INCALL ”;

connStatus = SUCCESS;
//obtain clientIp from SIP message here;
//obtain clientPort from SIP message here

}
break;
case 302:
{

cerr << “In REDIRECT:” << endl;
s << “REDIRECT ”;

connStatus = IN_PROGRESS;

}
break;
case 480:
case 486:
{

s << “BUSY ”;

connStatus = FAIL;

}
break;
case 404:
{

strstream s2;
s2 << “ERROR ” << “User not found” << endl;
s2 << endl << ends;
postMsg(s2.str( ));
s2.freeze(false)
s << “INFO ”;

connStatus = FAIL;

}
break;
case 403:
{

strstream s2;
s2 << “ERROR ” << “Host unreachable or

connection refused”;

s2 << endl << ends;
postMsg(s2.str( ));
s2.freeze(false);
s << “INFO ”;

connStatus = FAIL;

}
break;
case 408:
{

strstream s2;
s2 << “ERROR ” << “Request timed out, check

if Proxy_Server/URL is reachable”;

s2 << endl << ends;
postMsg(s2.str( ));
s2.freeze(false);
s << “INFO ”;

connStatus = FAIL;

}
break;
case 407:
case 487:
{

s << “INFO ”;

}
break;
case 401:
{

s << “UNAUTHORIZED ”;

connStatus = FAIL;

}
break;
case 603:
{

strstream s2;
s2 << “ERROR ” << “Request declined by the
callee”;
s2 << endl << ends;
postMsg(s2.str( ));
s2.freeze(false);
s << “INFO ”;

connStatus = FAIL;

}
break;
default:
{

s << “ERROR ”;

connStatus = FAIL;

}
break;

}

}
s << sMsg->encode( ).logData( ) << endl << ends;

}
else
{

if((sMsg->getType( ) == SIP_BYE) ||

(sMsg->getType( ) == SIP_CANCEL))

{

s << “R_HANGUP ” << sMsg->encode( ).logData( )
<< endl << ends;

}
else
{

s << “INFO ” << sMsg->encode( ).logData( )
<< endl << ends;

}

}
postMsg(s.str( ));
s.freeze(false);

}

FIG. 2C is a flow diagram of a method for sending a predetermined message to a destination, according to an embodiment of the invention. In the illustrated embodiment, sending step 222 begins by initializing parameters (e.g., destination IP address, port, codec, and/or a pre-recorded voice message buffer) in step 248, assigning a destination address in step 250, creating a client socket in step 252, and binding the socket to a local port in step 254.

Next, the process calls a start loop function in step 256. The process continues by setting a parameter “i” equal to 0 (zero) in step 258, initializing a next real-time protocol (RTP) packet in step 260, copying data to the next RTP packet in step 262, sending the RTP packet to the destination in step 264, waiting for the next sample time in step 266, and incrementing parameter i by 1 (one) in step 268. Then it is determined whether i is greater than a pre-determined packet number in conditional step 270. Where the result of conditional step 270 is in the affirmative, the process advances to step 272, which is the end of the sending loop. Where the result of conditional step 270 is in the negative, the process returns to step 260.

Accordingly, the process of FIG. 2C first creates a socket, then forwards all necessary packets to the destination using RTP.

The following source code listing, showing an exemplary code implementation for a portion of the process in FIG. 2C, contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

* This is the send voice packet module
*/
void
UaSpam::sendVoiceData(unsigned char* data, int packetNum, char

*destIp, int destPort)

{

int sd, rc, i, portNum;
struct sockaddr_in cliAddr, remoteServAddr;
struct hostent *h;
unsigned char b[4];
rtp_pkt_t rlast;
rtp_pkt_t rbuf;
portNum = destPort;
/* construct destination IP address */
h = gethostbyname(destIp);
if(h==NULL) {

printf(“%s: unknown host ‘%s’ \n”, argv[0], argv[1]);
exit (1);

}
printf(“%s: sending data to ‘%s’ (IP : %s) \n”, argv[0], h->h_name,

inet_ntoa(*(struct in_addr *)h->h_addr_list[0]));

remoteServAddr.sin_family = h->h_addrtype;
memcpy((char *) &remoteServAddr.sin_addr.s_addr,

h->h_addr_list[0], h->h_length);

remoteServAddr.sin_port = htons(portNum);
/* socket creation */
sd = socket(AF_INET,SOCK_DGRAM,0);
if(sd<0) {

printf(“%s: cannot open socket \n”,argv[0]);
exit(1);

}
/* bind the socket to local port */
cliAddr.sin_family = AF_INET;
cliAddr.sin_addr.s_addr = htonl(INADDR_ANY);
cliAddr.sin_port = htons(DEFAULT_TRANS_PORT);
rc = bind(sd, (struct sockaddr *) &cliAddr, sizeof(cliAddr));
if(rc<0) {

printf(“%s: cannot bind port\n”, argv[0]);
exit(1);

}
/*init rtp packet*/
memset (&rlast, 0, sizeof(rtp_pkt_t));
memset (&rbuf, 0, sizeof(rtp_pkt_t));
rlast.h.b0 = 0×80;
rlast.h.ssrc = 0×12345678;
for (i=0;i<packetNum;i++)

{

//Init the next rtp packet header

rlast.h.seq++;
rlast.h.ts+=160;
memcpy(&rbuf, &rlast, sizeof(rtp_pkt_t));
b[0] = (rlast.h.seq>>8)&0×FF;
b[1] = rlast.h.seq&0×FF;
rbuf.h.seq = (b[0]) + (b[1]<<8);
b[0] = (rlast.h.ts>>24)&0×FF; b[1] = (rlast.h.ts>>16)&0×FF;
b[2] = (rlast.h.ts>>8)&0×FF; b[3] = rlast.h.ts&0×FF;
rbuf.h.ts = b[0] + (b[1]<<8) + (b[2]<<16) + (b[3]<<24);

//copy data to the rtp packet
memcpy(rbuf.buf. data+i*160, 160);
//send packet out

rc = sendto(sd, &rbuf, sizeof(rtp_pkt_t), 0,

(struct sockaddr *) &remoteServAddr,
sizeof(remoteServAddr));

if(rc<0) {

printf(“%s: cannot send data %d \n”,argv[0],i−1);
close(sd);
return;

}

//wait for the next sample's time is up.

usleep(20000);

}

}

The methods described above with reference to FIGS. 2A, 2B, and 2C need not be combined. Any one or more of the processes in FIGS. 2A, 2B, and 2C may be used alone or in combination with any one or more of the processes in FIGS. 2A, 2B, and 2C.

Functional Architectures

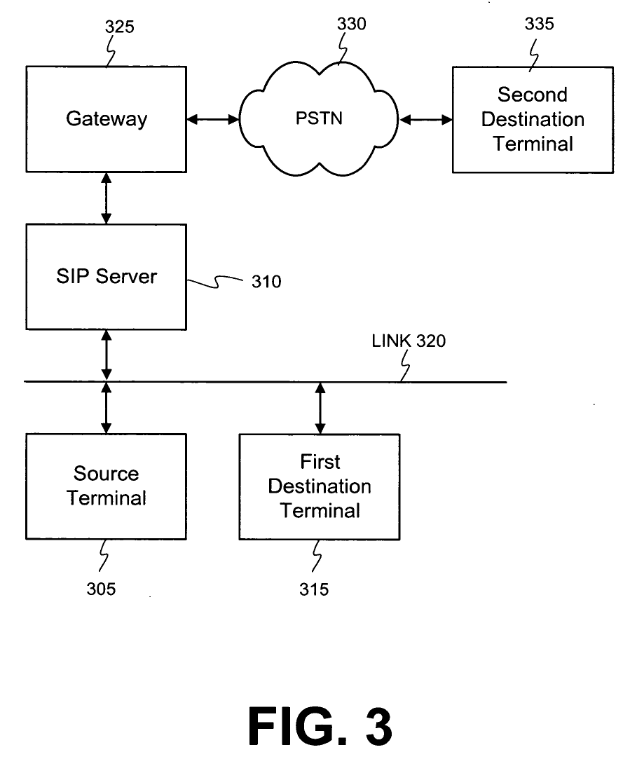

FIG. 3 is a block diagram of a functional architecture configured to broadcast VoIP messages, according to an embodiment of the invention. As shown in FIG. 3, a source terminal 305, a SIP server 310 and a first destination terminal 315 are coupled to each other via a link 320. SIP server 310 may also be coupled to second destination terminal via gateway 325 and public switched telephone network (PSTN) 330. Link 320 may be a portion of the Internet, an Intranet, a local area network (LAN), a wide area network (WAN) or other IP-based network.

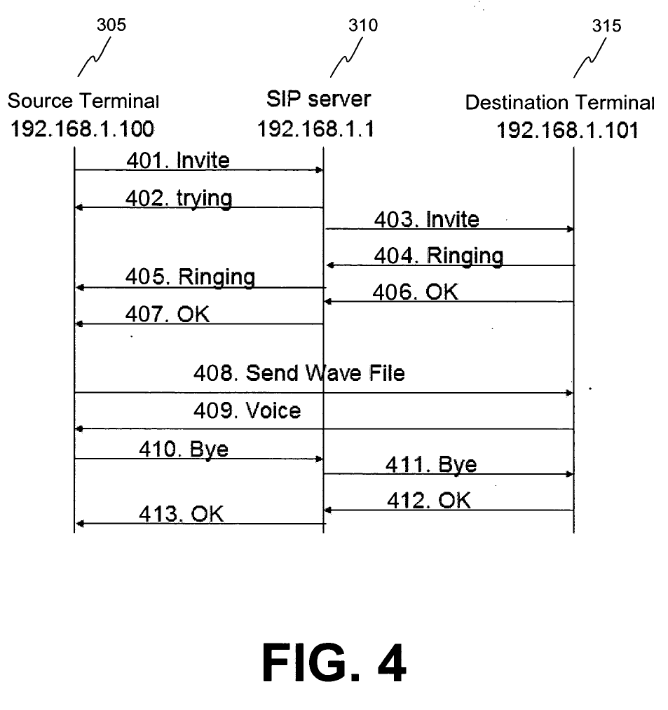

The illustrated embodiment uses Vovida Open Communication Library (VOCAL), which enables network-based VoIP services by using one or more SIP servers. Exemplary communications between the source terminal 305, the SIP server 310, and the first destination terminal 315 is described below with reference to FIG. 4.

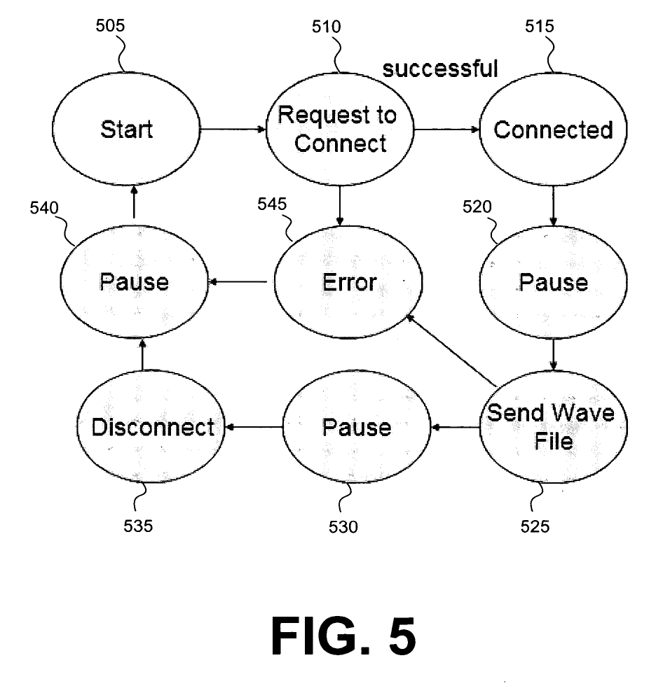

Source terminal 305 may be configured to execute the processes described above with reference to FIGS. 1, 2A, 2B, and/or 2C. For example, source terminal 305 may include a processor (not shown) and processor-readable memory (not shown) such that the processes described above with reference to FIGS. 1, 2A, 2B, and/or 2C can be embodied in processor-executable code (not shown) that is stored on the processor-readable memory (not shown) for execution by the processor (not shown). In the context of VOCAL, the processor-executable code (not shown) may be referred to as a User Agent (UA). An exemplary state diagram for the processor-executable code (not shown) is described below with reference to FIG. 5.

The quantity of functional components in FIG. 3 are for illustration purposes only. Moreover, alternative functional architectures are also possible. For example, similar messaging schemes using Media Gateway Control Protocol (MGCP), H.323 (an International Telecommunications Union (ITU) specification), or other Internet protocol may also be used, according to design choice.

FIG. 4 is a sequence diagram of communications between the source terminal 305, the SIP server 310, and the first destination terminal 315, according to an embodiment of the invention. The source terminal 305, the SIP server 310, and the first destination terminal 315 are associated with IP addresses 192.168.1.100, 192.168.1.1, and 192.168.1.101, respectively. The steps of the illustrated sequence are summarized in the table below.

| STEP | DESCRIPTION |
|---|---|
| 401 | SIP Invite from 192.168.1.100 to 192.168.1.1 |
| 402 | SIP Status: 100 trying from 192.168.1.1 to 192.168.100 |
| 403 | SIP Invite from 192.168.1.1 to 192.168.1.101 |
| 404 | SIP status: 180 Ringing from 192.168.1.101 to 192.168.1.1 |
| 405 | SIP status: 180 Ringing from 192.168.1.1. to 192.168.1.100 |
| 406 | SIP status: 200 OK from 192.168.1.101 to 192.168.1.1 |
| 407 | SIP status: 200 OK from 192.168.1.1 to 192.168.1.100 |
| 408 | Send wave file from 192.168.1.100 to 192.168.1.1 |
| 409 | Voice data from 192.168.1.101 to 192.168.1.100 |
| 410 | SIP request: bye from 192.168.1.100 to 192.168.1.1 |
| 411 | SIP request: bye from 192.168.1.1 to 192.168.1.101 |
| 412 | SIP status: 200 OK 192.168.1.101 to 192.168.1.1 |
| 413 | SIP status: 200 OK from 192.168.1.1 to 192.168.1.100 |

Accordingly, the messaging of sequences 401, 402, 403, 404, 405, 406, and 407 may implement a portion of connecting step 110. Likewise, message sequence 408 may implement sending step 125, and may include a text message. Sequence 409 indicates voice traffic from the destination terminal to the source terminal (which may be ignored at the source). Messaging sequences 410, 411, 412, and 413 may implement disconnecting step 135.

FIG. 5 is a state diagram of code for broadcasting VoIP messages, according to an embodiment of the invention. As shown therein, the state of a UA progresses from a “start” state 505 to a “request to connect” state 510. Where the “request to connect” 510 is successful, the state of the UA advances to a “connected” state 515 before a first “pause” state 520. Next, the UA advances to a “send wave file” state 525 before being promoted to a second “pause” state 530. Then, the UA advances to a “disconnect” state 535 and a third “pause” state 540 before returning to the “start” state 505.

From “request to connect” state 510, or “send wave file” state 525, the UA may also proceed to “error” state 545. Advantageously, the next state after “error” state 545 is the third “pause” state 540, leading to the “start” state 505.

Applications

The methods and systems described above can enable various applications. For example, commercial entities can send bulk voicemail to their customers, non-profit entities can contact potential contributors, organizations can contact members with information of broad interest, and emergency alerting services can provide warnings and/or instructions to targeted populations.

### CONCLUSION

The invention described above thus overcomes the disadvantages of known systems and methods by disguising the automated nature of the messaging source and by persisting when error messages are encountered. While this invention has been described in various explanatory embodiments, other embodiments and variations can be effected by a person of ordinary skill in the art without departing from the scope of the invention.

1. A method for broadcasting Voice Over IP (VoIP) messages, comprising:
connecting from a source to a first destination;
pausing for a first random duration; and
sending a first VoIP message from the source to the first destination.

2. The method of claim 1, the connecting from the source to the first destination including communicating with a SIP server.

3. The method of claim 1, the sending a first VoIP message including sending a text message.

4. The method of claim 1, the sending the first VoIP message occurring prior to the pausing for the first random duration.

5. The method of claim 1, further comprising:
pausing for a second random duration after sending the first VoIP message; and
disconnecting the source from the first destination.

6. The method of claim 5, further comprising:
pausing for a third random duration after disconnecting the source from the first destination;
connecting from the source to the first destination; and
sending a second VoIP message from the source to the first destination.

7. The method of claim 5, further comprising:
pausing for a third random duration after disconnecting the source from the first destination;
connecting from the source to a second destination; and
sending the first VoIP message from the source to the second destination.

8. A method for controlling a transmission of a Voice Over IP (VoIP) message by a source, comprising:
detecting a connection between the source and a first destination;
setting a first delay to a first duration; and
at the expiration of the first delay, transmitting a first VoIP message intended for the first destination from the source.

9. The method of claim 8, further comprising:
setting a second delay to a second duration; and
at the expiration of the second delay, disconnecting the source from the first destination.

10. The method of claim 9, further comprising:
setting a third delay to a third duration;
at the expiration of the third delay, connecting the source to a second destination; and
sending the first VoIP message to the second destination.

11. The method of claim 9, further comprising:
setting a third delay to a third duration;
at the expiration of the third delay, connecting the source to a first destination; and
sending a second VoIP message to the first destination.

12. A method for broadcasting Voice Over IP (VoIP) messages, comprising:
means for connecting from a source to a first destination;
pausing for a first random duration; and
sending a first VoIP message from the source to the first destination.

13. A machine-readable medium having instructions stored thereon for execution by a processor to perform a method comprising:
connecting from a source to a first destination;
pausing for a first random duration; and
sending a first VoIP message from the source to the first destination.

14. A machine-readable medium having instructions stored thereon for execution by a processor to perform a method comprising:
detecting a connection between the source and a first destination;
setting a first delay to a first duration; and
at the expiration of the first delay, transmitting a first VoIP message intended for the first destination from the source.

15. A system for broadcasting Voice Over IP (VoIP) messages, comprising:
a source terminal;
an interface to a SIP server coupled to the source terminal; and
an interface to a first destination terminal, the interface to the destination terminal coupled to the SIP server, the source terminal configured to detect a connection between the source and a destination, the source terminal further configured to set a first delay to a first duration, the source terminal further configured to transmit a first VoIP message to the destination after the expiration of the first delay.

16. The system of claim 15 further comprising:
a gateway coupled to the SIP server;
a Public-Switched Telephone Network (PSTN) coupled to the gateway; and
a second destination terminal coupled to the PSTN.
